(19) United States
(12) Patent Application Publication
(10) Pub. No.: US 2008/0154924 A1
(43) Pub. Date: Jun. 26, 2008

(54) DYNAMIC NETWORKING BY MATCHING PROFILE INFORMATION

(76) Inventors: Jun Ding, Knoxville, TN (US); Jing Xu, Knoxville, TN (US)

Correspondence Address: LUEDEKA, NEELY & GRAHAM, P.C., P O BOX 1871, KNOXVILLE, TN, 37901, US

(21) Appl. No.: 11/956,767

(22) Filed: Dec. 14, 2007

Related U.S. Application Data
(60) Provisional application No. 60/876,844, filed on Dec. 22, 2006.

(51) Int. Cl. G06F 17/30

(52) U.S. Cl. 707/100; 707/E17.044

(57) ABSTRACT

of a communication network. A message sender can attach a user-selected profile to a publicly-broadcasted message. A message viewer can read the publicly-broadcasted message only if the viewer's profile matches the sender's profile attached to the message. When a sender profile and viewer profile match, a communication channel is established between the sender and viewer. The sender's and viewer's profiles are registered on an open directory to which all parties, even parties unknown to each other, have access. The open directory structure is used in creating a header file, also referred to herein as a “stamp,” that is attached to messages or requests generated by the users. The selection of categories to be included in the header file is a procedure that is independent from the creation of the message. The header file can be combined dynamically at the point of sending the message by a message sender or at the point of searching messages by a message viewer. The messages may include text, graphics, audio or video. The broadcasting of the messages may occur via the Internet, radio, satellite, cable, and wired or wireless telephone networks.

This application claims priority to pending provisional patent application Ser. No. 60/876,844 entitled “Dynamic Networking by Matching Profile Information Attached on Public Broadcasted Messages Through Registration from an Open Directory” filed Dec. 22, 2006, the entire contents of which are incorporated herein by reference.

### FIELD

This invention relates to social networking on a global communication network. More particularly, this invention relates to a system for finding and communicating information based on categories of interest associated with users of a social network.

### BACKGROUND

As technology evolves, methods for communicating information evolve. From the land-line telephone to the cellular phone, from email to instant messaging, the range and scope of communication methods change over time. However, all direct party-to-party communication methods require one party to know the address of the other party, i.e., a telephone number or an email address. On the other hand, an Internet message board is a place where strangers meet without knowing each other's names or addresses. Although message boards and on-line chatting are typically free, they do not provide trustworthy and secure methods of social networking.

Some social networking websites, such as Facebook.com and Myspace.com, use categories or interest groups to assist their users in connecting with others having similar interests. However, these categories and interest groups are pre-defined and static. They do not reflect the dynamic and constantly changing interests of the users.

What is needed, therefore, is a system for online social networking which is trustworthy and secure, which does not require users to know contact information for other users, and which provides for the dynamic and constantly changing interests of the users.

### SUMMARY

The present invention is directed to overcoming the shortcomings of prior communications methods implemented via the Internet. According to various embodiments of the present invention, a message sender can attach a user-selected profile to a publicly-broadcasted message. A message viewer can read the publicly-broadcasted message only if the viewer's profile matches the profile attached to the message. When a sender profile and viewer profile match, a communication channel is established between the sender and viewer. The sender's and viewer's profiles are registered on an open directory to which all parties, even parties unknown to each other, have access. The open directory structure is used in creating a header file, also referred to herein as a “stamp,” that is attached to messages or requests generated by the users. In preferred embodiments of the invention, the selection of categories to be included in the header file is a procedure that is independent from the creation of the message. The header file can be combined dynamically at the point of sending the message by a message writer or at the point of searching messages by a message viewer. The messages may include text, graphics, audio or video. The broadcasting of the messages may occur via the Internet, radio, satellite, cable, and wired or wireless telephone networks.

Various embodiments of the invention provide: an open directory of user characteristics from which registered users may choose in creating their user profiles; a mechanism for attaching user profiles to messages that are broadcast over a communication network; and an algorithm for determining matches between user profiles attached to messages and creating communication channels between users when matches are found.

In one preferred embodiment, the invention provides a computer-implemented method for facilitating communication between users of a communication network. The method includes (a) providing a database containing a plurality of records, where each record contains information regarding at least one characteristic of one or more of the users of the communication network. The method also includes (b) selecting from the database one or more records to be included in a user characteristic list, and (c) creating the user characteristic list from the records selected from the database. The method further includes (d) associating the user characteristic list with a graphical symbol (also referred to herein as a “stamp”), and (e) associating the graphical symbol with a particular user of the communication network.

In another preferred embodiment of the invention, the method includes (a) providing at least one graphical symbol for each user of the communication network, where the graphical symbol is associated with at least one characteristic of the user of the communication network. The method includes (b) storing a plurality of the graphical symbols in a database, where each graphical symbol is associated with a corresponding one of the users of the communication network. The method also includes (c) searching the database for one or more user characteristics associated with one or more of the plurality of graphical symbols, and (d) displaying a listing of one or more graphical symbols associated with the one or more user characteristics searched in step (c). The method further includes (e) selecting at least one of the graphical symbols from the displayed listing, and (f) sending a message to the user of the communication network that is associated with the selected graphical symbol.

In yet other embodiments, the method includes (a) providing at least one graphical symbol for each user of the communication network, where the graphical symbol is associated with at least one characteristic of the user, and (b) storing the graphical symbols in a database wherein each graphical symbol is associated with a corresponding one of the users of the communication network. The method also includes (c) storing a plurality of data files, where each data file is stored in association with a graphical symbol selected from the plurality of graphical symbols stored in step (b). The method further includes (d) searching the data files for at least one graphical symbol having a particular user characteristic associated therewith, (e) searching the data files for particular file content, and (f) displaying a listing of one or more matching data files, where each matching data file contains the particular file content and has the particular user characteristic associated with its graphical symbol.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a two-layer dynamic networking structure according to a preferred embodiment of the invention;

FIG. 2 depicts a computer network system on which the two-layer dynamic networking structure may be implemented;

FIG. 3 depicts a process for creating a stamp according to a preferred embodiment of the invention;

FIG. 4 depicts a process for searching for people according to a preferred embodiment of the invention;

FIG. 5 depicts a process for posting a stamp according to a preferred embodiment of the invention;

FIG. 6 depicts a process for searching for files according to a preferred embodiment of the invention;

FIGS. 7A and 7B depict processes for encoding and decoding a stamp according to a preferred embodiment of the invention; and

FIG. 8 depicts a User Message Board according to a preferred embodiment of the invention.

### DETAILED DESCRIPTION

Definitions. Following are definitions of various terms used herein in describing preferred embodiments of the invention.

User characteristics. User characteristics describe various characteristics of users of a social networking system. For example, a user characteristic may be a place, a language, a profession, a thing, an experience, or even a secret that two or more people may have in common. A user characteristic may be system-generated or it may be submitted by users.

Directory. A directory is a collection of user characteristics. In preferred embodiments of the invention, the directory is a searchable database or lookup table of user characteristics.

Category. A category refers to one record of the directory. In preferred embodiments, the category contains key words representing user characteristics, a counter representing a number of times a category has been checked out and data indicating relationships, if any, with other categories.

User profile. A user profile is a list or set of one or more user characteristics selected from the directory. Each user may have more than one profile, and the content of each profile may vary according to the context of messages or files associated with the profile. Each user creates the content of his or her profile(s) by selecting user characteristics from the directory.

Communication channel. A communication channel is established between a message sender and a message receiver when the user profiles of the sender and receiver match.

Dynamic Networking. Dynamic networking is a process for creating communication channels between message senders and message receivers that have mutual interests as defined by their user profiles. The process is dynamic in the sense that the user profiles used in establishing the communication channels may vary from message to message. Thus, network channels may be continuously changing.

Header file. A header file is a file that contains the user profile. The header file may be attached to or combined with a message file or a document file.

Stamp. A stamp is a graphical symbol in which the header file is encoded.

Network Structure.

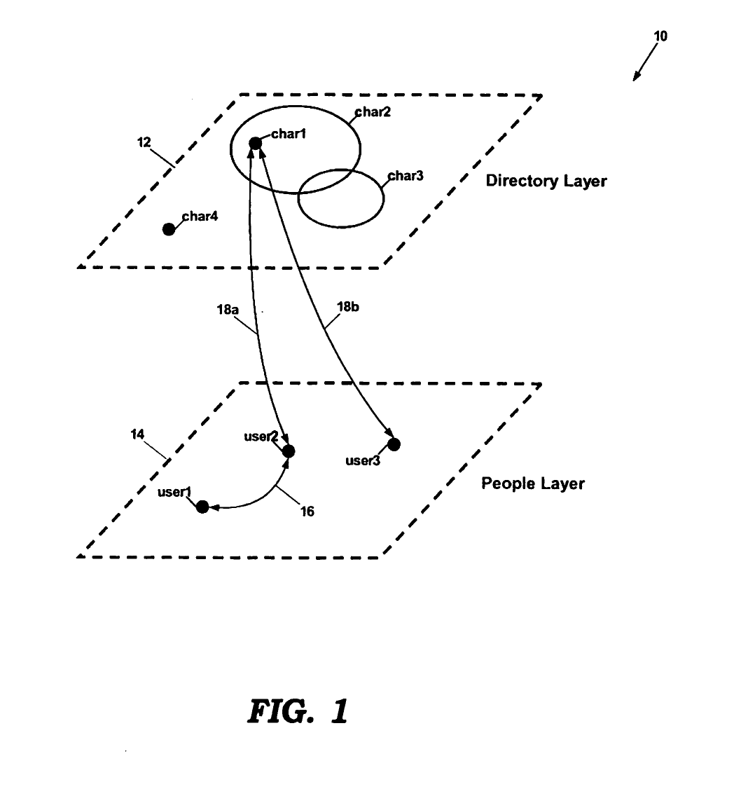

According to preferred embodiments of the invention, dynamic networking is implemented in a two layer structure 10 as depicted in FIG. 1. The two-layer structure 10 comprises a first layer 12, also referred to herein as a directory layer, and a second layer 14, also referred to herein as a people layer. In the directory layer, the nodes are user characteristics. A user profile may comprise a single user characteristic (such as char1) or a combination of user characteristics (such as char1 and char4). There may be several relationships between these user characteristics. For example, a characteristic (such as char1) may be a subset of another characteristic (such as char2). A characteristic (such as char3) may intersect another characteristic (such as char2). Some characteristics (such as char4) may be completely isolated from other characteristics.

In the people layer 14, nodes are users (people), such as user1, user2 and user3. Users in the people layer 14 can be connected via channels to form a social network. Connections that exist completely in the people layer 14 are referred to herein as a direct communication channels. For example, user1 is connected to user2 through a direct communication channel 16, such as in a situation where user1 knows the address of user2. Users may also be connected via indirect communication channels that are established through the directory layer 12. As shown in FIG. 1, user2 has a connection 18a with user characteristic char1 in the directory layer. User3 also has a connection 18b with user characteristic char1. Although user2 and user3 may not know each other, but they can be connected through an indirect communication channel comprising channel connections 18a and 18b (user2→char1→user3).

If q(n) denotes a number of indirect channels (such as 18a and 18b), and p(n) denotes a number of direct channels (such as 16), according to the invention, q(n) is much larger than p(n). Thus, the directory layer greatly increases the number of possible connections between users. It should also be noted that indirect channels are not limited by time and space restrictions.

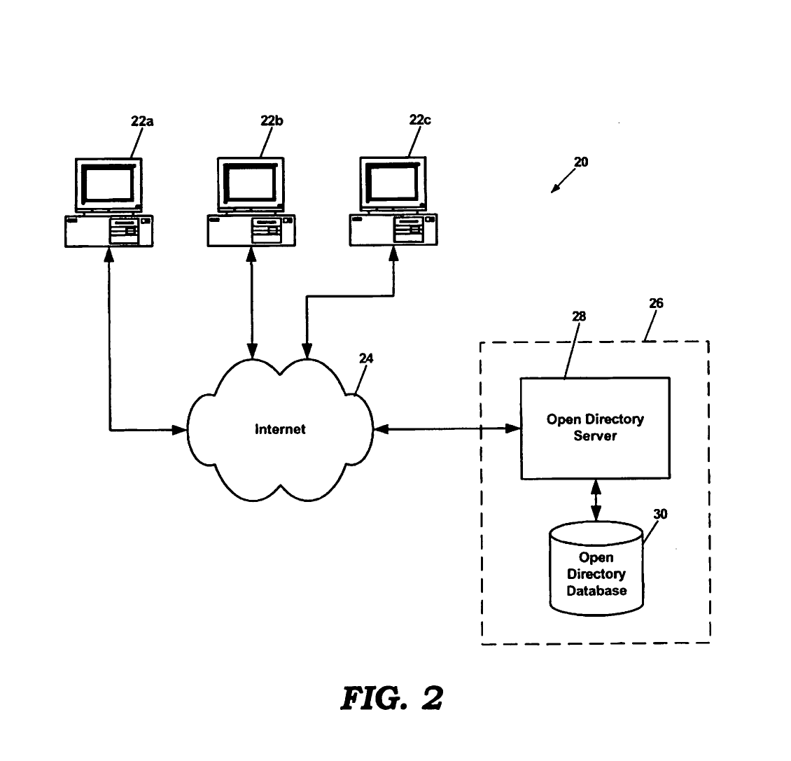

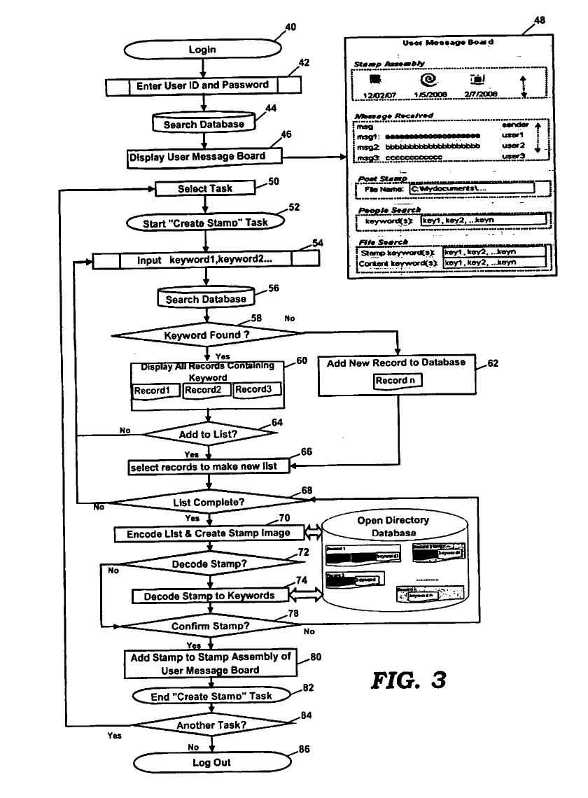

In preferred embodiments of the invention, the two-layer structure 10 of FIG. 1 is implemented on a computer network system 20 as depicted in FIG. 2. The system 20 includes multiple user computers, such as personal computers 22a-22c, connected to a global computer network 24, such as the Internet. Also connected to the network 24 is an open directory computer system 26 which includes an open directory server 28 and an open directory database 30.

Mathematical Proofs. As set forth below, indirect channel communication improves the quality of social networking and the accuracy of searching. Assume P(A) is the probability of the occurrence of an event A, such as a message being viewed by a user. Event A is defined in an event space C which represents all channels that users having access to the message. Space C can be partitioned into k mutually independent subspaces, such as C1, C2, C3 . . . Cₖ, which correspond to direct channels and indirect communication channels (such as channels 16, 18a and 18b in FIG. 1). In particular, C1 is one of the indirect channels. For a given channel, such as C1 (channel 18a and 18b),

$$P ( A / {C}_{1} ) = \frac{P ( A ⋂ {C}_{1} )}{P ( {C}_{1} )} = \frac{P ( A )}{P ( {C}_{1} )} > P ( A ) .$$

Thus, P(A|C1)>P(A). Accordingly, the message is more likely to be viewed by incorporation of a user profile (combination of user characteristics in the directory layer) to establish indirect communication channels between users (in the people layer).

Additionally, “noise” in the message communication process is filtered by establishing indirect communication channels through the incorporation of user profiles in messages. For a user profile that comprises n number of user characteristics i (where i=1, 2, 3, . . . n), we let pᵢ represent the probability that a user has been truthful in entering a characteristic i in the user's profile. We let qᵢ represent the probability that a user has not been truthful in entering a characteristic i in the user's profile. For example, out of 100 users, 60 users may truthfully claim to own a particular stock, and 40 users may claim to own the stock but actually do not. In this case, pᵢ=0.60 and qᵢ=0.40. We define the signal-to-noise ratio as:

$${r}_{i} = \frac{{p}_{i}}{{q}_{i}} .$$

Continuing with the example above, the signal-to-noise ratio for the stock characteristic is:

$${r}_{i} = \frac{{p}_{i}}{{q}_{i}} = \frac{0.60}{0.40} = 1.5 .$$

Typically, for most user characteristics, rᵢ>1, which means over all, it is more likely that a user will be truthful rather than untruthful. If more than one user characteristic is included in the user profile (n>1), the combined signal-to-noise ratio r_{c} is expressed as:

$${r}_{c} = {\prod }_{i = 1}^{n} {r}_{i} > {r}_{i}$$

Consider an example where a user profile comprises two user characteristics: (1) ownership of a particular stock and (2) graduation from a particular primary school. For ownership of the stock, r₁=1.5. For graduation from the primary school, assume r₂=99 (indicating users are much less likely to be untruthful about which primary school they attended). The combined signal-to-noise ratio for the two user characteristics is expressed as:

$${r}_{c} = \frac{{p}_{1}}{{q}_{1}} \times \frac{{p}_{2}}{{q}_{2}} = \frac{0.60}{0.40} \times \frac{0.99}{0.01} = 148.5$$

Note that if the probability of truthfulness is much greater than the probability of untruthfulness for any one specific user characteristic in a user profile comprising a group of characteristics (pᵢ>>qᵢ), then the combined signal-to-noise ratio for the group of characteristics will be much greater than the signal-to-noise ratio for each individual characteristic (r_{c}>>rᵢ).

Directory Structure.

The directory is the key to indirect channel communication. In preferred embodiments of the invention, the directory consists of many entries (user characteristics) compiled in a lookup table or database 30 (FIG. 2). Each entry has a unique sequence code in the lookup table. Once created, the sequence code and lookup table are preferably fixed. For example, the gender of a user may be assigned entry 1, where a female is designated by “00” under entry 1 and a male is designated by “01” under entry 1. This gender entry may be represented by the notation “1{00, 01}”. In another example, the age of a user may be assigned entry 2, where age 0-10 years is designated by “000” under entry 2, 11-20 years is designated by “001”, 21-30 years is designated by “010”, 31-40 years by “011”, 41-50 years by “100”, 51-60 years by “101”, 61-70 years by “110”, and 80 years and older by “111”. Using this scheme, the age entry may be represented by the notation “2{000,001,010,011,100,101,110,111}”. The directory is designed to encompass all potential interests that a user may have. Thus, there may be many more entries corresponding to other user characteristics, such as language, education, profession, health care, sports, entertainment, travel, consumer products, financial status, etc. Although the directory structure is defined by system settings, the contents of the directory can be determined by submissions from users. The directory is “open” in two sense, one is that it can be accessed by public, the other is that it is expandable by public.

A typical user profile may include user characteristics such as the language spoken by the user, schools from which the user graduated, classes taken by the user, places the user has visited, the user's profession, stocks owned by the user, hospitals and physicians visited by the user, products consumed by the user, sports interests and teams supported by the user, the political party supported by the user, etc. When used in channel communication, these user characteristics may be jointly applied. For example, a communication channel may be opened between two users that own the same stock and also graduated from the same school. For a user who gives more weight to the opinions of others who graduated from his school, the application of both of these user characteristics functions as a “noise filter.” Thus, compared to Internet stock-related message boards that are open to anyone, the invention greatly improves the credibility and value of discussions.

Examples of Channel Communications

User Alice posts a message on a message board with a user profile C_{A}, where C_{A} is a set of user characteristics related to Alice and her interests. For example, C_{A}={char1, char2, char3, char4, char5, char6}. User Bob, who has a user profile C_{B}, logs on to the message board. Following are several examples where Bob may or may not be able to view Alice's message.

Example 1. C_{B}={char1}. Since C_{B}∩C_{A}=char1≠0, Alice's message is displayed for Bob via a common channel established through char1

Example 2. C_{B}=C_{BI}∪C_{BF}, where C_{BI}={char7} and C_{BF}={char2}. With OR filtering, C_{B}∩C_{A}=(C_{BI}∩C_{A})∪(C_{BF}∩C_{A})=0∪char2=char2≠0. Thus, Alice's message is displayed for Bob via a common channel established through char2.

Example 3. C_{B}=C_{BI}∪C_{BF}, where C_{BI}={char1} and C_{BF}={char7}. With AND filtering, C_{B}∩C_{A}=(C_{BI}∩C_{A})∩(C_{BF}∩C_{A})=char1∩0=0. In this case, there is no common channel and Alice's message is not displayed for Bob.

Example 4. C_{B}={char7}. C_{B}∩C_{A}=0. Since char7 is not in Alice's profile, there is no common channel for networking and Alice's message is not displayed for Bob.

Creating a Header File.

In a preferred embodiment of the invention, a user can create a header file by logging onto an open directory website maintained on the open directory server 28 (FIG. 2). The user then searches the open directory database 30 by typing in key words. The directory server 28 responds to the user by listing existing categories that contain the searched key words and number of people who have already selected each category. For example, a user may type in “University of Tennessee.” The directory responds with the categories listed in Table I.

TABLE I

| | Number of Users |
|---|---|
| Category | Claiming Category |
| University of Tennessee | 20033 |
| University of Tennessee, Business School | 4567 |
| University of Tennessee, Law school | 2345 |
| University of Tennessee, Nuclear | 145 |
| Engineering Department | |

Now the user selects “University of Tennessee, Nuclear Engineering Department” as a user characteristic to be included as an entry in his user profile. A graphical symbol, also referred to herein as a stamp, is created for later use. After the user's selection, the directory database is updated as shown in Table II. Because “University of Tennessee, Nuclear Engineering Department” is included in the “University of Tennessee” category, the number of users in both categories increased by 1.

TABLE II

| | Number of Users |
|---|---|
| Category | Claiming Category |
| University of Tennessee | 20034 |
| University of Tennessee, Business School | 4567 |
| University of Tennessee, Law school | 2345 |
| University of Tennessee, Nuclear | 146 |
| Engineering Department | |

Next the user types in “Laurel apartments” as a search term. The directory server 28 responds with the categories listed in Table III.

TABLE III

| Category | Number of Users Claiming Category |
|---|---|
| Laurel apartments, University of | 5300 |
| Tennessee housing | |
| Laurel apartments, Chicago | 456 |
| Laurel apartments, Florida | 23 |

Now the user selects “Laurel apartments, University of Tennessee housing” as a user characteristic to be included as an entry in his user profile. A corresponding graphical symbol (stamp) is created for later use. After the selection, the directory database is updated as shown in Table IV.

TABLE IV

| Category | Number of Users Claiming Category |
|---|---|
| Laurel apartments, University of | 5301 |
| Tennessee housing | |
| Laurel apartments, Chicago | 456 |
| Laurel apartments, Florida | 23 |

Next the user types in “Smokey Mountain Hiking” as a search term. The directory server 28 responds with the category shown in Table V.

TABLE V

| Category | Number of Users Claiming Category |
|---|---|
| Smokey Mountain hiking group | 3455590 |

Now the user selects “Smokey Mountain hiking group” as a user characteristic to be included as an entry in his user profile. A corresponding graphical symbol (stamp) is created for later use. After the selection, the directory database is updated as shown in Table VI.

TABLE VI

| Category | Number of Users Claiming Category |
|---|---|
| Smokey Mountain hiking group | 3455591 |

Now the user has three graphical symbols (stamps) assigned: one for “University of Tennessee, Nuclear Engineering Department”; one for “Laurel apartments, University of Tennessee housing”; and one for “Smokey Mountain hiking group.” These three symbols may be combined to create a header file which may be assigned the named “ULS”. This header file may also be encoded as a stamp for use in posting and viewing messages, document files, image files, video files, audio files, etc.

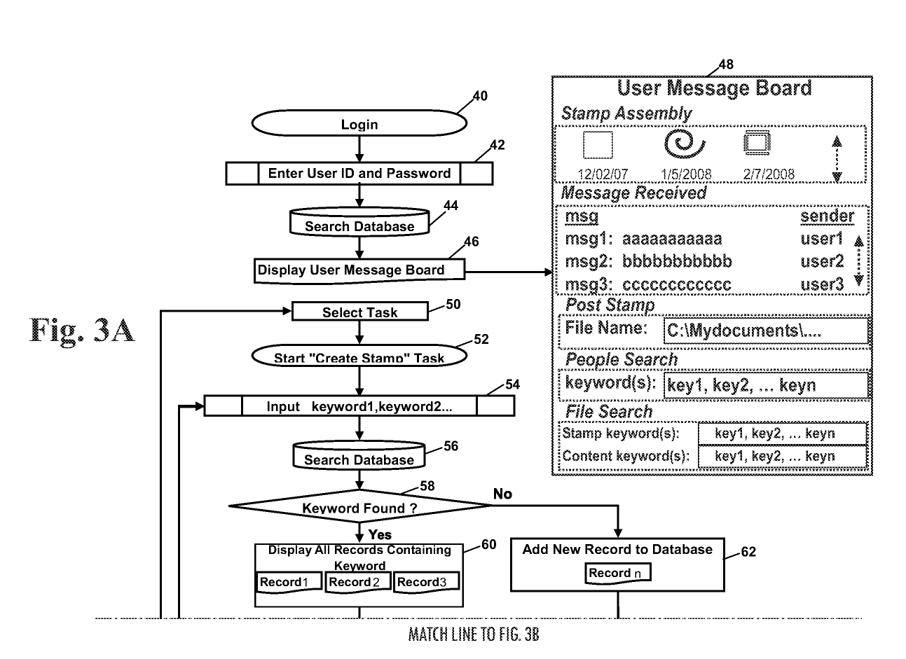

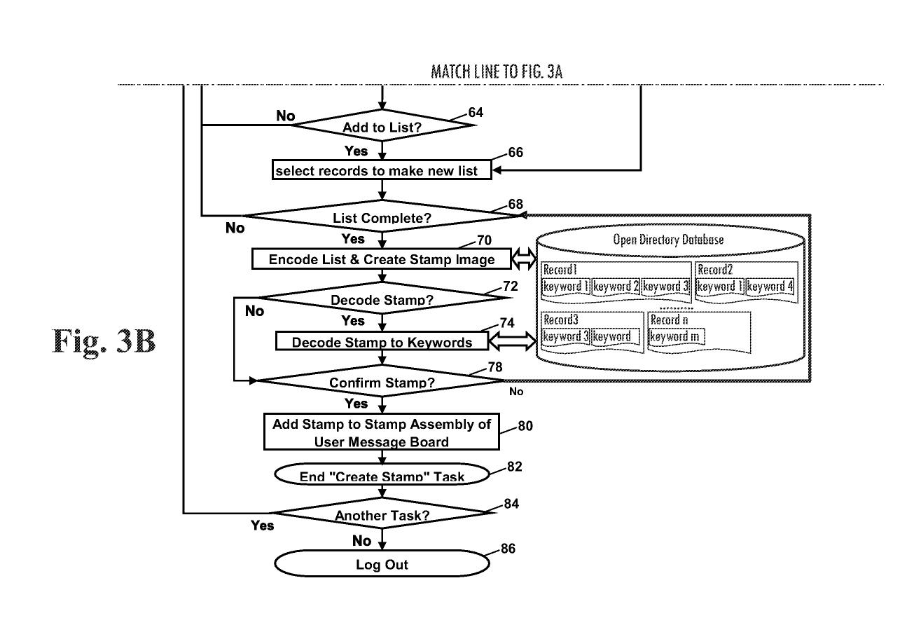

FIG. 3 depicts a process for creating a stamp according to a preferred embodiment of the invention. This process may be performed using the system depicted in FIG. 2. As shown in FIG. 3, a user logs in to the open directory system 26 (step 40) by entering a user ID and password (step 42). The directory database 30 is searched to verify the user's login information and retrieve information needed to display the user's User Message Board 48 (step 46).

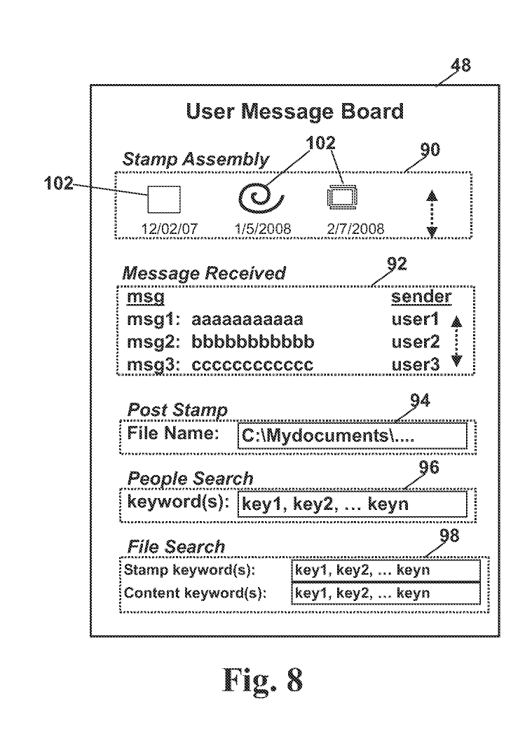

An example of the format of the User Message Board 48 is depicted in FIG. 8. The User Message Board 48 is preferably displayed on a display device associated with the user's computer (such as personal computer 22a). In a preferred embodiment, the User Message Board 48 includes a Stamp Assembly dialog box 90, a Message Received dialog box 92, a Post Stamp dialog box 94, a People Search dialog box 96 and a File Search dialog box 98. The purpose and function of each of these dialog boxes is described in more detail below.

At this point, a user can choose to perform one of several tasks. These include creating a stamp, posting a stamp, searching people and searching files. The process of creating a stamp is depicted in FIG. 3 beginning at step 52. First, the user enters one or more keywords, where each keyword is associated with a user characteristic (such as “University of Tennessee”) (step 54). The open directory database 30 is searched for the entered keywords (step 56). If one or more of the keywords are found in the database (step 58), all records containing the found keywords are displayed (step 60). For example, the records listed in Table I above may be displayed for the keyword “University of Tennessee.” If the entered keyword is not found in the database 30 (step 58), a new record for this keyword is added to the database 30 (step 62).

If the user wishes to select one or more of the displayed records to create a new list (step 64), the user selects those records (step 66). The word “list” is used herein to refer to a collection of records that are associated together. A list of records may also be referred to herein as a set of records. If the user does not wish to select any of the displayed records for the list (step 64), the user has the option of entering other keywords (step 54). If the list is still not complete after selecting one or more of the displayed records (step 68), the user has the option of entering other keywords (step 54).

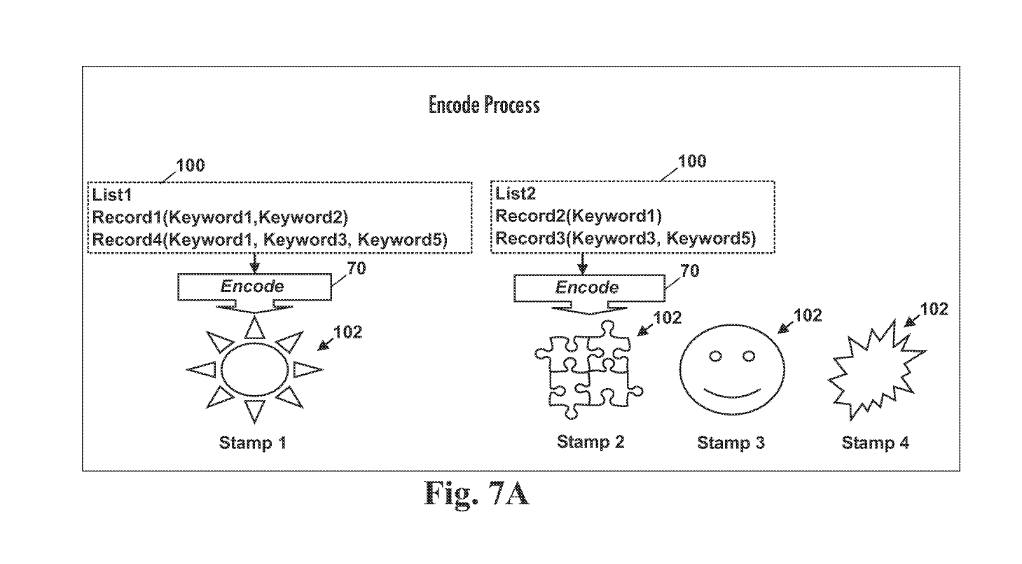

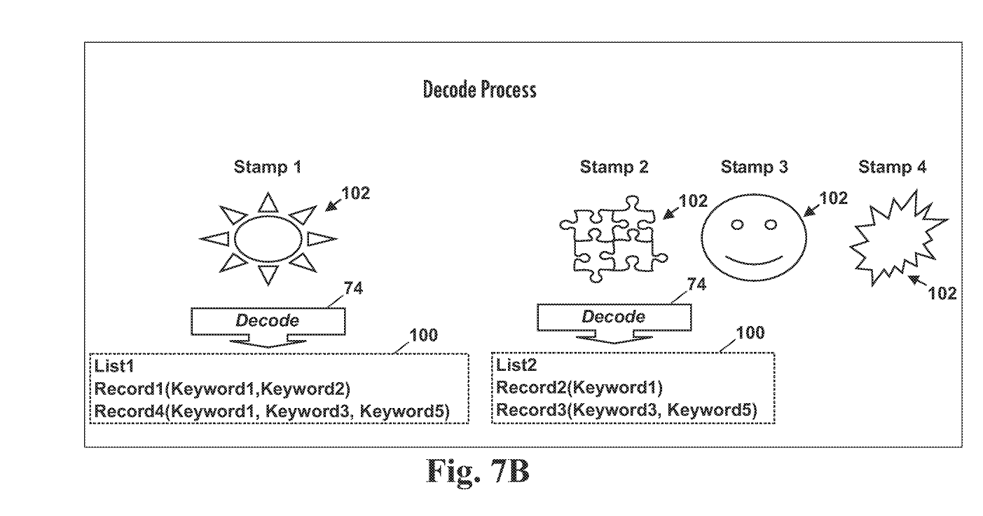

When the list is complete (step 68), the list of selected records is encoded and a stamp image is created (step 70). The stamp encoding process is depicted in FIG. 7A. Encoding can be accomplished in at least three different ways in various embodiments of the invention. In a first embodiment, the encoding of the stamp can be plain, wherein keywords are displayed in an image format. In a second embodiment, the encoding of the stamp involves an encryption process which is public. For example, index numbers of the records in the list are linked together to create a two-dimensional barcode image. The barcode image is then added to a normal image to create a stamp image. The stamp image of this embodiment thus contains both normal image information and bar code information, and the latter can be decoded into index numbers of records in the open directory. In a third embodiment, the encoding of the stamp involves encryption which is private. In this embodiment, the stamp image only can be decoded when the encryption method is known.

Generally, the stamp 102 may incorporate any graphical symbol (within predetermined size constraints) that the user wishes to associate with the list 100 being encoded. The process depicted in FIG. 7A associates the encoded list 100 with the selected symbol to form the stamp 102. As shown in FIG. 7A, the user may generate several different stamps 102 to encode several different lists of records 100.

The user has the option (step 72) to decode the stamp into the associated keywords (step 74) so as to confirm that the stamp correctly represents the desired list (step 78). The decode process is depicted in FIG. 7B. If the stamp does not correctly represent the desired list, the user has the option to modify the list beginning at step 68. If the stamp is confirmed (step 78), the stamp is added (step 80) to the Stamp Assembly 90 dialog box in the User Message Board 48 (see FIG. 8). As shown in FIG. 8, the Stamp Assembly dialog box 90 is a scrollable listing of stamps 102 that have been created by the user.

At this point, the user has the option to perform another task (steps 84 and 50) or log out (steps 84 and 86).

Using a Header File in Posting Messages.

In preferred embodiments of the invention, the header file may be used in posting a message. For example, suppose a user wishes to post a message on a personal blog. The user can do it in a usual way, such as posting it on a blog website. However, the user can also post the message with a header file, such as the “ULS” stamp discussed above. The message can now be searched in the usual way, based on the content (text) of the message, and it can be searched based on the “ULS” header information.

For example, Larry maintains a travel journal on a website he created. He likes to make friends through his online journal. Larry has posted many pictures, stories and travel tips related to places he has visited. However, very few visitors view Larry's online travel journal. If one executes a key word search for “travel journal” using a standard search engine, Larry's web page is far down on the list. A current popular search engine uses reference rules to determine the priority of the listing of search “hits.” In other words, if Larry's web page is viewed more often, he could have a higher rank in the search engine. Though his webpage has been viewed by many, it is not searchable to the current search engine standard.

If Larry adds the open directory header file to his webpage, his webpage gains another dimension to be searched. A search engine that is capable of searching on the open directory header file information and the webpage content information gives Larry's webpage more visibility and more visits.

Using a Header File in Searching Messages.

As mentioned previously, the header file may also be used to search messages. Suppose a user wants to search content with the “ULS” header file discussed above. A search engine which can recognize open directory headers and search based on the headers will find all content that is associated with the “ULS” header.

For example, every time Jerry types in a search string to do a search on a popular search engine, thousands of web pages are listed, some of which are relevant and some of which are not. Jerry is very concerned about the environment and global warming in particular. When Jerry searches the web for topics related to global warming, he notices that the search engine returns some pages presenting the point of view of the big oil companies which deemphasize the existence and effects of global warming. Some pages present the point of view of the environmentalists, especially after the release of an Oscar-winning movie by a former U.S. vice president. With conventional search engines, Jerry does not have a choice regarding which point of view is contained in the web pages listed.

Using a search engine that is compatible with the open directory, Jerry has a choice. He is able to create a header file to indicate his profile, including his interests with regard to global warming. Using the header file, Jerry is able to search the web with more focus on web pages that are consistent with his point of view.

Using a Header File in Finding People.

The header file may also be used to find people online. A user may logon to a messaging service website with a header file the user obtained from the open directory. The messaging service website responds with an indication of how many people with the same header file are currently online and the availability for communication with those people.

For example, Sue wakes up in the morning and is concerned about a stock she owns. The overall stock market is bearish but her stock has potential to do well since the company just patented a technology to extract hydrogen using nuclear power. Sue knows that hydrogen has potential as a fuel for cars. But Sue is a medical doctor and knows little about nuclear power. She knows that her financial advisor also knows nothing about nuclear power. Sue logs onto a stock-related Internet message board. As expected, the messages posted there indicate that many people are buying and many people are selling this particular stock. Sue is not sure who to listen to.

However, Sue graduated from a medical school at a university that has a prestigious nuclear engineering department. She knows that opinions of nuclear engineering graduates from her school will be trustworthy. But Sue graduated thirty years ago and no longer knows anybody in nuclear engineering.

Using the open directory system 26, Sue types in her user ID and password. Her computer connects to the open directory server 28 which responds with a display of users that are currently online. She finds 2000 users graduated from her school. She finds 1000 users who claim to own the stock of interest. She finds that 200 users both graduated from her school and own the stock. She is unable to narrow the search to nuclear engineering (NE) graduates, because that information is not available to her. She then types in an instant message: “An MD is seeking someone graduated from NE” which is sent to the 200 users that went to her school and own the stock. However, there is nothing in her message to indicate that those users were picked because they own the stock. After a while, three NE graduates respond to Sue's message, and ask her various questions about healthcare. She sets up a temporary discussion forum and patiently answers the questions they have. At last, Sue raises a question about the hydrogen stock. One of the discussion participants mentions that the technology is feasible and will be very economical. Another participant mentions that a national regulatory change is very likely to occur soon that will make the technology more desirable. Based on this information, Sue decides not to sell her stock. The next day, a national regulatory authority publishes a regulatory change regarding nuclear energy. The regulatory change will result in more use of nuclear energy for hydrogen production. The stock Sue owns has doubled in value.

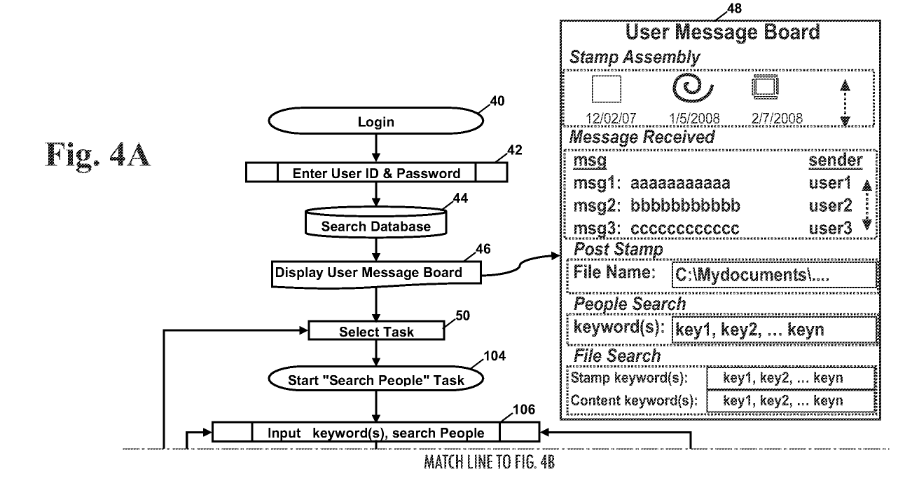

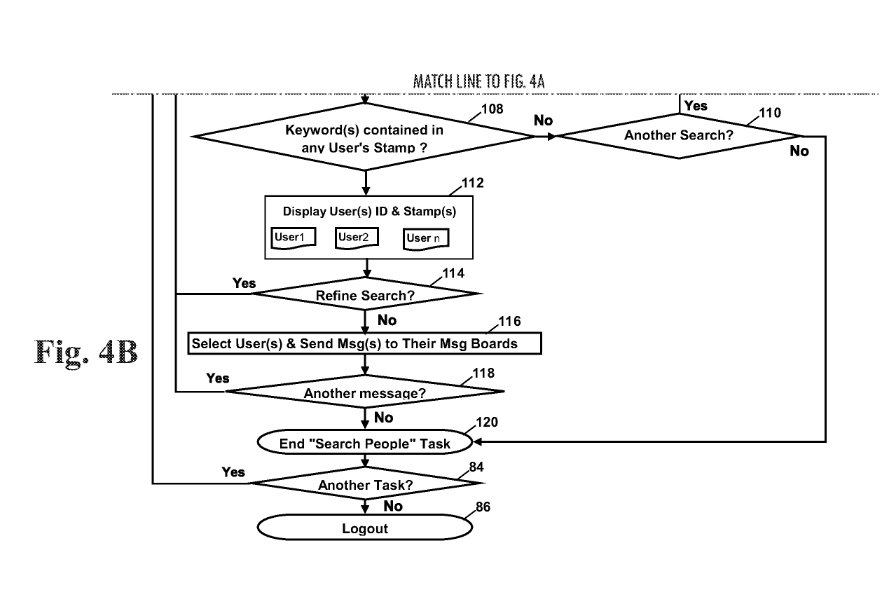

FIG. 4 depicts a process for searching for people using the system depicted in FIG. 2. As shown in FIG. 4, a user logs in to the open directory system (step 40) by entering a user ID and password (step 42). The directory database 30 is searched to verify the user's login information and retrieve information needed to display the user's User Message Board 48 (step 46).

At this point, a user can choose to perform one of several tasks. These include creating a stamp, posting a stamp, searching people and searching files. The process of searching people is depicted in FIG. 4 beginning at step 104. First, the user enters one or more keywords, where each keyword is associated with a user characteristic (such as “University of Tennessee”) (step 106). The open directory database 30 is then searched for the entered keywords (step 107). If the keywords are found in any user stamp in the database 30 (step 108), all stamps containing the keywords and the associated user ID's are displayed (step 112). If the entered keyword is not found in any stamp in the database 30 (step 108), the user has the option to conduct another search (steps 110 and 106) or to end the search task (step 120).

After the stamps having the searched keywords are displayed (step 112), the user has the option of narrowing or refining the search by introducing additional keywords in an AND combination with the previously searched keywords (steps 114 and 106). Steps 108 and 112 are then repeated with the new search terms. The user may select one or more of the users found in the search and send a message which will be displayed in the User Message Boards 48 (FIG. 8) of those users (step 116). At this point the user has the option of looping back from step 118 to perform more searches and send more messages, or ending the people search task (step 120) to perform another task (step 84) or log out (step 86).

Posting a Stamp

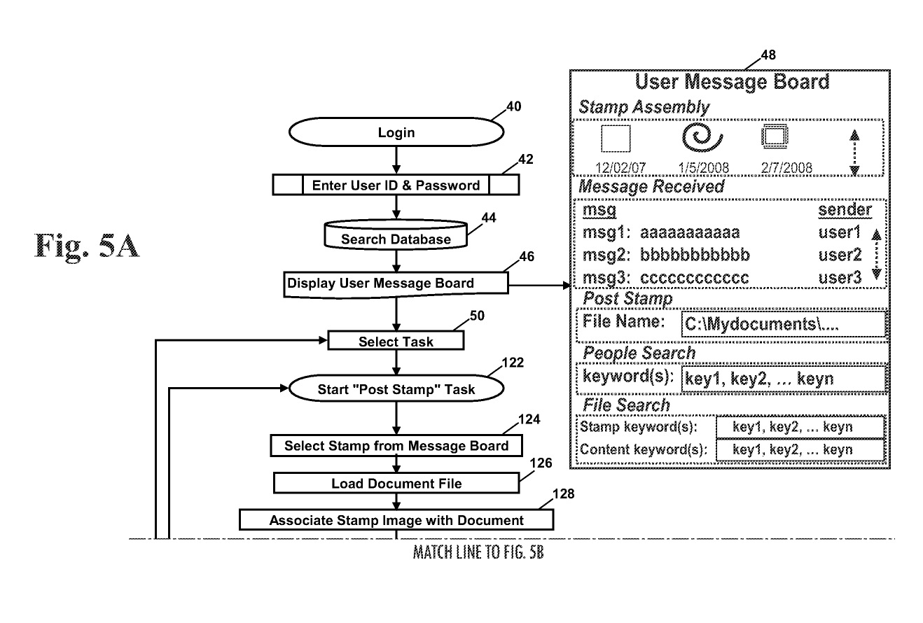

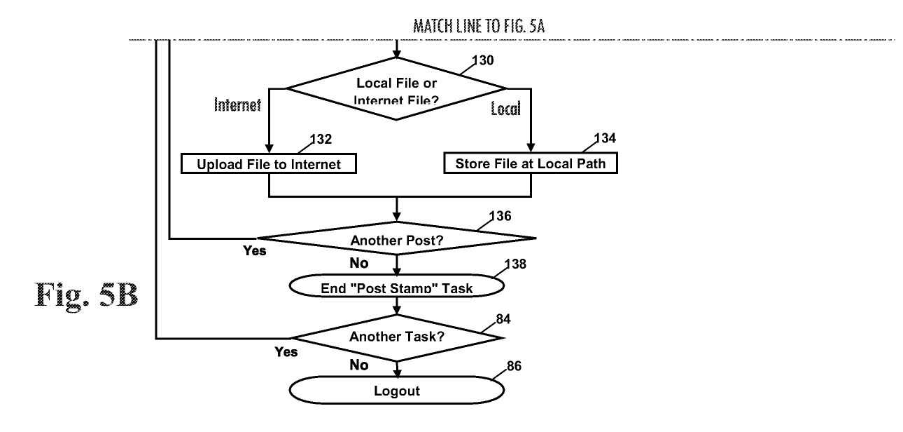

FIG. 5 depicts a process for posting a stamp using the system depicted in FIG. 2. As shown in FIG. 5, a user logs in to the open directory system (step 40) by entering a user ID and password (step 42). The directory database 30 is searched to verify the user's login information and retrieve information needed to display the user's User Message Board 48 (step 46).

At this point, a user can choose to perform one of several tasks. These include creating a stamp, posting a stamp, searching people and searching files. The process of posting a stamp is depicted in FIG. 5 beginning at step 122. First, while viewing the User Message Board 48 (see FIG. 8), the user selects a stamp 102 from the stamp assembly 90 (step 124). The user next selects a document file (step 126) with which the selected stamp 102 is to be associated (step 128). If the document file is a local file (on the user's local computer drive), the file with the associated stamp is stored on the local drive at a path indicated by the user (step 134). If the document file is a remote file (on a remote drive accessible via the Internet), the file with the associated stamp is uploaded via the Internet to the remote drive at an address indicated by the user (step 132).

At this point the user has the option of looping back from step 136 to post more stamps, or ending the stamp posting task (step 138) to perform another task (step 84) or log out (step 86).

Using a Header in Finding Files.

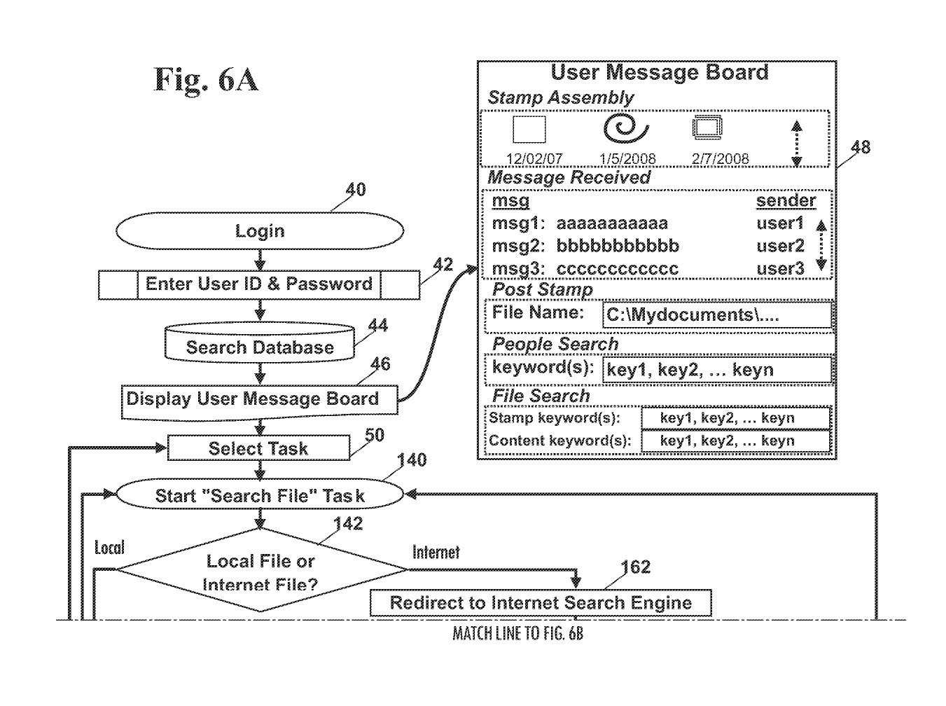

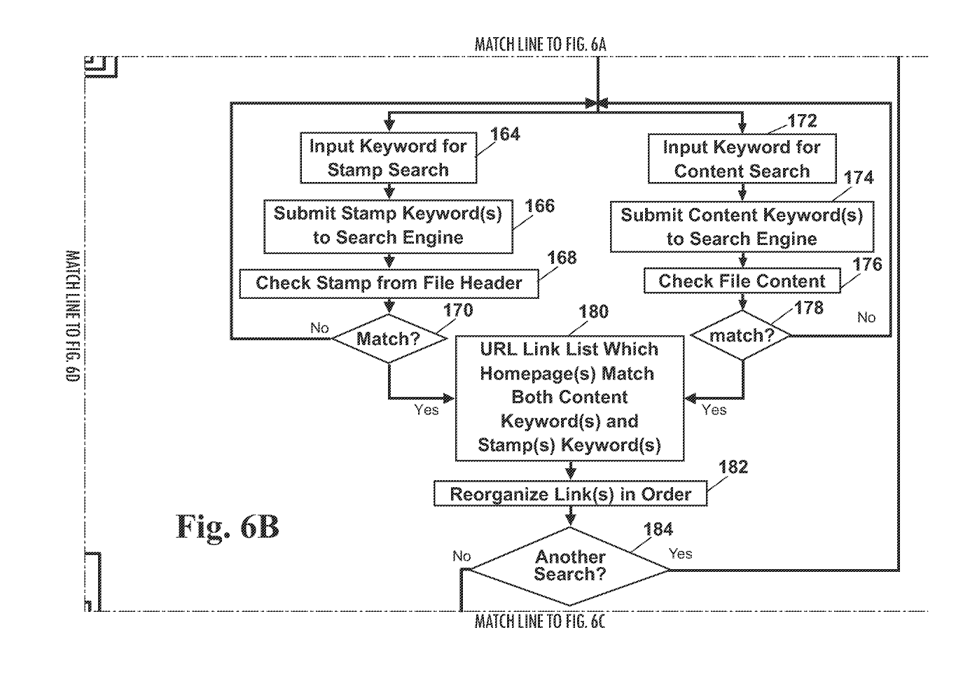

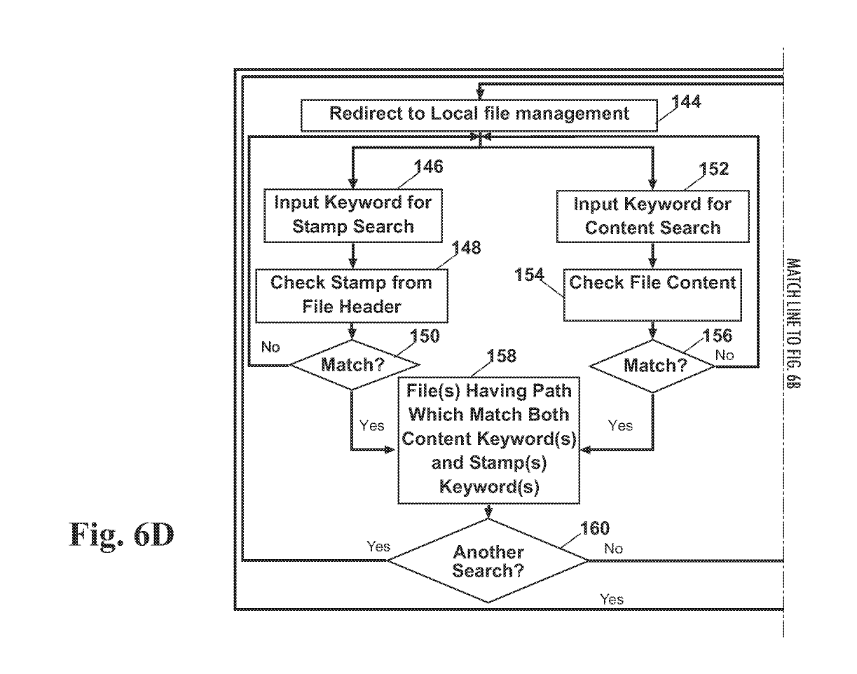

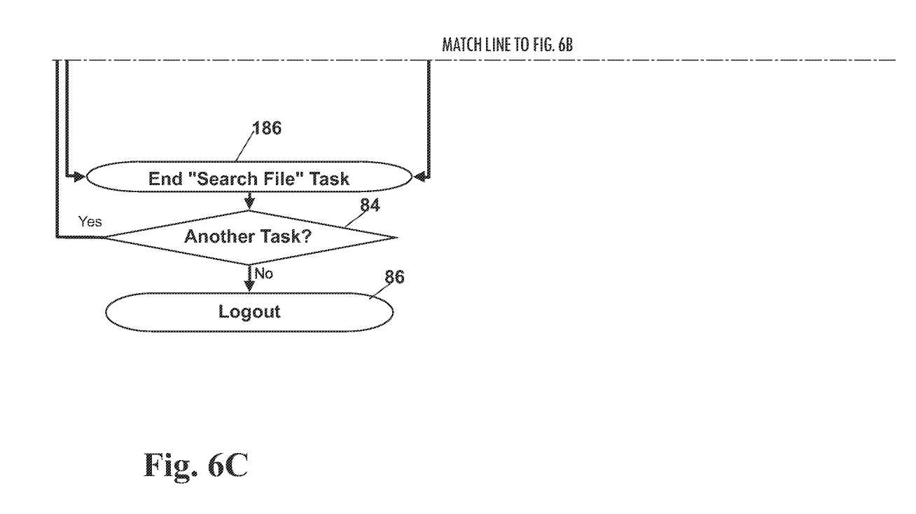

FIG. 6 depicts a process for searching for files using the system depicted in FIG. 2. As shown in FIG. 6, a user logs in to the open directory system 26 (step 40) by entering a user ID and password (step 42). The directory database 30 is searched to verify the user's login information and retrieve information needed to display the user's User Message Board 48 (step 46).

At this point, a user can choose to perform one of several tasks. These include creating a stamp, posting a stamp, searching people and searching files. The process of searching files is depicted in FIG. 6 beginning at step 140. First, the user indicates whether the file search is to be conducted on the user's local computer/network or using an Internet search engine (step 142). If it is a local search, a local file management module is used (step 144). If it is an Internet search, an Internet search engine is used (step 162).

With continued reference to FIGS. 6 and 8, the user enters one or more stamp keywords and one or more content keywords in the File Search dialog box 98 of the User Message Board 48 (steps 146, 152, 164, 172). The system then searches for the entered stamp keywords in stamps that have been posted to local files (step 148) or posted to Internet files (steps 166 and 168). The system also searches for the entered content keywords in the content of local files (step 154) or in the content of Internet pages (steps 174 and 176). If one or more files are found in the local search which include a stamp match and a content match (steps 150 and 156), those files are listed for the user (step 158). If one or more web pages are found in the Internet search which include a stamp match and a content match (steps 170 and 178), Uniform Resource Locator (URL) links corresponding to the matched pages are listed for the user (steps 180 and 182).

At this point the user has the option of looping back from step 160 (or 184) to conduct another search, or ending the file search task (step 186) to perform another task (step 84) or log out (step 86).

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer-implemented method for facilitating communication between users of a communication network, the method comprising:
(a) providing a database containing a plurality of records, where each record contains information regarding at least one characteristic of one or more of the users of the communication network;
(b) selecting from the database one or more records to be included in a user characteristic list;
(c) creating the user characteristic list from the one or more records selected from the database;
(d) associating the user characteristic list with a graphical symbol; and
(e) associating the graphical symbol with a particular user of the communication network.

2. The method of claim 1 wherein step (d) further comprises encoding the user characteristic list into a graphic file representing the graphical symbol.

3. The method of claim 1 further comprising searching the database to locate records to be included in the user characteristic list.

4. The method of claim 3 further comprising creating a new record to be added to the database for any user characteristic that is not found during the searching step.

5. The method of claim 1 further comprising creating a listing of one or more graphical symbols that have been associated with a particular user of the communication network.

6. The method of claim 5 further comprising displaying on a user message board the listing of graphical symbols associated with the particular user of the communication network.

7. The method of claim 5 further comprising selecting a graphical symbol from the listing and associating the selected graphical symbol with a data file selected from the group consisting of a message file, a document file, a text file, a graphic file, a video file, an image file and an audio file.

8. The method of claim 1 further comprising:
(f) storing in the database a plurality of graphical symbols associated with a plurality of users of the communication network;
(g) searching the database for one or more user characteristics associated with one or more of the plurality of graphical symbols;
(h) displaying a listing of one or more graphical symbols associated with the one or more user characteristics searched in step (g);
(i) selecting one of the graphical symbols from the listing displayed in step (h); and
(j) sending a message to the user of the communication network that is associated with the graphical symbol selected in step (i).

9. The method of claim 1 further comprising:
(f) storing a plurality of data files, each stored in association with a corresponding graphical symbol or a plurality of graphic symbols;
(g) searching the plurality of data files for at least one graphical symbol having a particular user characteristic associated therewith;
(h) searching the plurality of data files for particular file content; and
(i) displaying a listing of one or more matching data files, where each matching data file contains the particular file content and has the particular user characteristic associated with its graphical symbol.

10. The method of claim 9 wherein the data files are selected from the group consisting of message files, document files, text files, graphic files, video files, image files and audio files.

11. The method of claim 1 further comprising encoding the graphical symbol to plain text which displays user characteristics.

12. The method of claim 1 further comprising encoding the graphical symbol using a public encryption method.

13. The method of claim 12 wherein the graphical symbol includes a barcode.

14. The method of claim 1 further comprising encoding the graphical symbol using a private encryption method.

15. A computer-implemented method for facilitating communication between users of a communication network, the method comprising:
(a) for each user of the communication network, providing at least one graphical symbol which is associated with at least one characteristic of the user of the communication network;
(b) storing in a database a plurality of the graphical symbols, each associated with a corresponding one of the users of the communication network;
(c) searching the database for one or more user characteristics associated with one or more of the plurality of graphical symbols;
(d) displaying a listing of one or more graphical symbols associated with the one or more user characteristics searched in step (c);
(e) selecting at least one of the graphical symbols from the listing displayed in step (d); and
(f) sending a message to the user of the communication network that is associated with the at least one graphical symbol selected in step (e).

16. A computer-implemented method for facilitating communication between users of a communication network, the method comprising:
(a) for each user of the communication network, providing at least one graphical symbol which is associated with at least one characteristic of the user of the communication network;
(b) storing in a database a plurality of the graphical symbols, each associated with a corresponding one of the users of the communication network;
(c) storing a plurality of data files, each stored in association with a graphical symbol selected from the plurality of graphical symbols stored in step (b);
(d) searching the plurality of data files for at least one graphical symbol having a particular user characteristic associated therewith;
(e) searching the plurality of data files for particular file content; and
(f) displaying a listing of one or more matching data files, where each matching data file contains the particular file content and has the particular user characteristic associated with its graphical symbol.
